(19) United States
(12) Patent Application Publication
(10) Pub. No.: US 2026/0288654 A1
(43) Pub. Date: Sep. 24, 2026

(54) POWER-OPTIMIZED CACHE ARCHITECTURE USING DISTANCE-BASED WAY ALLOCATION

(71) Applicant: QUALCOMM Incorporated, San Diego, CA (US)

(72) Inventors: Sandip Ghosh, Bangalore (IN); Hiral Nandu, South San Francisco, CA (US); Rakesh N, Bangalore (IN); Kedar Bhole, San Diego, CA (US); Raunaq Nandy Majumdar, San Diego, CA (US); Subbarao Palacharla, San Diego, CA (US)

(21) Appl. No.: 19/085,817

(22) Filed: Mar. 20, 2025

(51) Int. Cl. G06F 12/122; G06F 1/3234; G06F 12/0871

(52) U.S. Cl. CPC G06F 12/122; G06F 1/3275; G06F 12/0871

(57) ABSTRACT

A cache architecture reduces power consumption by considering the physical placement of cache ways relative to the last-level cache controller. The architecture monitors client access patterns and cache way distances to optimize power usage during cache operations. Cache ways located closer to the controller consume less power when accessed compared to more distant ways. The architecture leverages this characteristic by allocating closer ways to high-frequency or active clients while assigning distant ways to low-frequency or inactive clients. A cache replacement policy maintains way groups based on physical distance and prioritizes replacement selection from closer groups. This approach achieves power reduction without requiring modifications to the underlying cache structure. Implementation options include both software-managed allocation and hardware-based replacement mechanisms.

### TECHNICAL FIELD

This disclosure relates generally to integrated circuit design, and more specifically, to power optimization in cache architectures through distance-aware allocation of cache ways.

### BACKGROUND

System-on-chip designs often incorporate large cache memories to meet growing performance demands where a last-level cache controller (LLCC) manages extensive cache structures that can reach sizes of 40 MB or more. In conventional implementations, cache ways are physically distributed across the silicon die to accommodate design constraints and optimize chip area utilization. But, the physical distribution of cache ways creates a significant but sometimes overlooked challenge. For instance, the power required to access different cache ways varies substantially based on their physical distance from the cache controller. Traditional cache management schemes focus primarily on temporal and spatial locality of data access patterns while treating all cache ways as equal from a power perspective. Such approaches generally fail to account for the impact of physical placement on power consumption.

Also, conventional cache replacement policies, such as least-recently-used (LRU) or pseudo-LRU algorithms, make replacement decisions without considering the physical location of cache ways. Similarly, traditional way allocation strategies assign cache resources based on client priorities or access patterns, but do not factor in the power implications of way selection. As a result, high-frequency cache accesses may be directed to physically distant ways, which leads to unnecessary power consumption. And the power impact of physical distance becomes particularly pronounced in large cache systems where some ways can be significantly farther from the controller than others. In such scenarios, accessing distant cache ways can consume substantially more dynamic power than accessing nearby ways.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later. The systems and devices of this disclosure each have several innovative aspects, no single one of which is solely responsible for the desirable attributes disclosed herein.

One innovative aspect of the subject matter described in this disclosure can be implemented in an apparatus. The apparatus includes a cache memory including a plurality of storage locations configured as ways, a cache controller, and cache logic. The cache logic is configured to select a first subset of the ways located closer to the cache controller for allocation to a first client having a higher access frequency, and select a second subset of the ways located farther from the cache controller for allocation to a second client having a lower access frequency. This distance-aware allocation architecture enables systematic management of cache resources while optimizing power consumption.

In some examples, the cache logic implements sophisticated way management through a sub-cache table storing way reservations for each client. The architecture leverages the physical characteristics of the cache, recognizing that accessing the first subset of ways is associated with lower power consumption than accessing the second subset of ways. The cache logic extends its allocation strategy by dynamically allocating ways located closer to the cache controller to active clients while allocating ways located farther from the cache controller to inactive clients. The architecture supports multi-core implementations, as the first client and second client may comprise different processing cores accessing the cache memory.

Another innovative aspect of the subject matter described in this disclosure can be implemented in a cache system. The cache system includes a cache memory having a plurality of storage locations configured as ways in cache banks, a cache controller, and cache logic. The cache logic maintains at least one of a first way group comprising ways located within a first distance from the cache controller and a second way group comprising ways located beyond the first distance from the cache controller. During cache operations, the logic selects a replacement way from the first way group before selecting from the second way group when performing cache replacement, implementing a distance-aware replacement strategy.

In some examples, the cache system incorporates sophisticated control mechanisms through a programmable vector storing way assignments for the first and second way groups. A client control vector provides granular control by enabling or disabling way group preferences on a per-client basis. Within each way group, the cache logic performs most-recently-used replacement while maintaining the overall distance-based grouping strategy. The power efficiency of this approach is demonstrated as accessing ways in the first way group produces less power consumption than accessing ways in the second way group. The replacement logic implements a structured evaluation sequence, first checking for invalid lines in the first way group, then checking the second way group only when necessary. This sequence extends to deactivated lines, checking the first way group and proceeding to the second group only after exhausting closer options. The logic further manages capacity by checking for over-capacity lines in a similar sequential manner. Line evaluation follows priority levels, examining the first way group before proceeding to the second group, with specific attention to checking lower priority lines before equal priority lines within each group. The entire replacement strategy operates under a modified least-recently-used policy that systematically prioritizes ways in the first way group over the second way group.

Another innovative aspect of the subject matter described in this disclosure can be implemented in a method for cache management. The method includes allocating a plurality of storage locations configured as ways in a cache memory, selecting a first subset of the ways located closer to a cache controller for allocation to a first client having a higher access frequency, and selecting a second subset of the ways located farther from the cache controller for allocation to a second client having a lower access frequency.

In some examples, the method maintains way assignments through storing way reservations for each client in a sub-cache table. The method accounts for power characteristics, recognizing that accessing the first subset of ways is associated with lower power consumption than accessing the second subset of ways. Active clients receive preferential allocation of ways located closer to the cache controller, while inactive clients are allocated to more distant ways. The method supports multi-core operations as the first and second clients may comprise different processing cores accessing the cache memory. Dynamic adaptation is achieved through monitoring access frequencies of the first and second clients and reallocating ways between the first and second subsets responsive to changes in the access frequencies. The method maintains detailed client state information indicating whether each client is active or inactive and implements reallocation responsive to changes in this state information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

The integrated circuits and System on Chips (SoCs) described herein may be used for processing of various kinds of data, including audio signal processing, video processing, artificial intelligence (AI) processing, mathematical computations, database processing, image processing, and other kinds of data processing. These integrated circuits and/or SoCs can be incorporated into a wide variety of devices. By way of example, they may be incorporated into stand-alone audio devices, such as entertainment devices and personal media players, wireless communication device handsets such as mobile telephones, cellular or satellite radio telephones, personal digital assistants (PDAs), tablets, gaming devices, computing devices such as webcams, video surveillance cameras, or other devices that process data using processing circuitry (e.g., application specific integrated circuits (ASICs), digital signal processors (DSP), graphics processing unit (GPU), or central processing units (CPU)).

In some aspects, a device may include a digital signal processor or a processor (e.g., an application processor) including specific functionality for data processing. Operations on different kinds of data may be performed by different processors, or various operations may be split between the various data processing circuitry (e.g., ASICs, DSP, GPU, CPU, NPU). In some embodiments, the methods and techniques disclosed herein may be adapted for use in a neural signal processor (NSP) in which one or more parameters of data processing are controlled based on output from a machine learning (ML) model executed by the NSP.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos (with associated or embedded sounds) in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### DESCRIPTION OF THE FIGURES

The present disclosure is described in connection with exemplary embodiments illustrated in the accompanying figures. It should be understood that the figures are for illustrative purposes and are not drawn to scale. In the figures, like reference numbers indicate identical or functionally similar elements. Additionally, in some cases, the same reference number may be used to identify different views of the same element in the figures. Further, it should be understood that the particular embodiments described herein are not to be construed as limiting and that other implementations incorporating the concepts described herein may be used.

FIG. 1 shows a block diagram of a system-on-chip (SoC) configured for performing power-optimized cache operations according to one or more aspects of this disclosure.

FIG. 2 shows a flowchart illustrating a process for performing placement-aware cache allocation in an integrated circuit device according to one or more aspects of this disclosure.

FIG. 3 shows a block diagram of an example system-on-chip apparatus implementing a distance-aware cache allocation architecture according to one or more aspects of this disclosure.

FIG. 4 shows a flowchart illustrating a process for implementing distance-aware cache replacement in way groups according to one or more aspects of this disclosure.

FIG. 5 shows a block diagram of an example system-on-chip apparatus implementing a placement-aware cache architecture through distance-based way groups according to one or more aspects of this disclosure.

Like reference numbers and designations in the various drawings indicate like elements.

### DETAILED DESCRIPTION

The present disclosure describes cache architectures and techniques that optimize power consumption by implementing distance-aware cache management strategies for last-level cache controllers (LLCC). A placement-aware cache architecture, as described herein, addresses power implications arising from the physical distribution of cache ways across silicon dies. Implementations can use a control framework incorporating both hardware and software mechanisms to manage cache resources based on their physical proximity to the cache controller, client access patterns, and dynamic workload characteristics. Here, described architectures implement a way grouping mechanism that organizes cache ways based on their physical distance from the LLCC while maintaining coordinated access through standardized allocation and replacement protocols. Each cache way group can incorporate dedicated control logic comprising programmable vectors and priority-based replacement circuitry configured to perform local cache operations. A centralized cache controller integrates way management logic to coordinate allocation and replacement operations across the distributed ways. The sub-cache table structure maintains detailed way assignments across clients based on monitored access patterns and activity states, which enables resource allocation based on both distance and usage.

Implantations described herein can incorporate structured replacement mechanisms through evaluation sequences that explicitly consider physical placement during cache operations. This distance-aware replacement logic implements multi-stage evaluation policies that check for available ways in closer groups before examining more distant options. Further, implementations can incorporate programmable control vectors that enable precise management of way assignments while maintaining power optimization across different cache utilization scenarios, e.g., from high-frequency client accesses to low-activity periods requiring resource redistribution.

Described architectures can extend beyond static allocation strategies by implementing dynamic monitoring of client behavior patterns and cache resource utilization. Implementations can track access statistics and activity states across clients, enabling continuous optimization of way assignments as usage patterns evolve. Dedicated power monitoring features provide detailed insights into the power consumption characteristics of different way groups, facilitating refined allocation strategies while maintaining cache performance objectives. Also, for high cache allocation scenarios, Described architectures implements specific mechanisms to manage power consumption through strategic way assignment. The system allocates ways nearer to the LLCC controller for high-frequency clients, directly reducing power costs for common access patterns. This allocation strategy utilizes the sub-cache table to maintain way reservations while considering both physical placement and client access characteristics.

In low cache allocation scenarios, described architectures implement additional control mechanisms to maintain power efficiency. The system allocates ways nearer to the LLCC controller for active clients while directing inactive client accesses to more distant ways. This adaptive approach enables power optimization even during periods of reduced cache utilization, supported by programmable vectors that maintain way assignments across different client states.

Particular implementations of the subject matter described in this disclosure may be implemented to realize one or more of the following potential advantages or benefits. In some aspects, the present disclosure provides techniques for achieving measurable reductions in dynamic power consumption through systematic management of cache resources based on physical placement characteristics. By implementing comprehensive distance-aware cache management strategies, Described architectures reduces power consumption associated with accessing physically distant cache ways without requiring modifications to fundamental cache structures or compromising cache functionality. For example, accessing ways located closer to the cache controller can reduce dynamic power consumption by up to 80% compared to accessing distant ways.

The placement-aware architecture enables consistent power optimization across diverse cache utilization scenarios through coordinated allocation and replacement mechanisms. During high allocation periods, the system maintains power efficiency by systematically assigning ways based on client access frequencies and physical proximity to the cache controller. In low allocation scenarios, Described architectures redistributes cache resources to ensure active clients maintain priority access to power-efficient ways while inactive clients utilize more distant resources. This adaptive approach preserves optimal power characteristics across varying workload conditions while maintaining cache performance objectives.

Integration of both hardware-based and software-based control mechanisms provides implementation flexibility while ensuring consistent resource management. Programmable vectors and priority-based replacement mechanisms enable precise control over cache resource allocation, while the sub-cache table structure supports dynamic adaptation based on observed client behavior patterns. Through this coordinated approach, Described architectures achieves consistent power optimization while preserving the ability to accommodate varying performance requirements across different operational scenarios. Also, multi-stage evaluation sequence implemented during replacement operations ensures methodical application of power-aware policies without introducing significant complexity. By evaluating closer ways before considering more distant options, Described architectures maintains power efficiency during cache replacement while preserving compatibility with existing cache protocols. The priority-based evaluation mechanism integrates naturally with established replacement policies while adding comprehensive distance awareness capabilities.

Described architectures can include parallel support for static way-based partitioning and dynamic allocation that provides extensive operational flexibility. Software-programmable registers in the sub-cache table enable precise control over way assignments on a per-client basis, while hardware-based replacement mechanisms maintain efficient operation during cache accesses. Such a dual-path implementation approach allows the system to accommodate diverse client requirements while preserving power optimization benefits across different usage scenarios. The dynamic adaptation capabilities enable continuous optimization as workload characteristics evolve over time. Through monitoring of client access patterns and activity states, certain implementations can redistribute cache resources to maintain optimal power efficiency under changing conditions. The described architecture's ability to track specific power consumption characteristics across different way groups enables ongoing refinement of allocation strategies while preserving cache performance objectives. This monitoring framework provides the foundation for systematic power optimization across varying operational conditions while maintaining full cache functionality.

Further, the programmable control structures provide granular management capabilities without imposing rigid constraints. Described architectures implements way group vectors that store detailed assignments while enabling dynamic updates based on changing access patterns. Per-client control vectors allow selective enabling or disabling of way group preferences, supporting flexible power optimization strategies across different client types and workload characteristics. This programmable framework accommodates varying requirements while maintaining systematic power management.

In certain implementations, a structured cache replacement policy incorporates physical placement awareness through a defined evaluation hierarchy. When performing cache replacement, described architectures first examine invalid lines in closer way groups before proceeding to more distant groups. This evaluation sequence extends through multiple stages—checking deactivated lines, over-capacity lines, and priority levels—while maintaining consistent consideration of physical placement. The replacement mechanism thereby achieves power optimization goals through standard cache operations.

A monitoring framework can provide ongoing insights into cache utilization patterns without additional overhead. By tracking client access frequencies and activity states during normal operations, described architectures accumulate data to inform way allocation decisions. Power monitoring features measure actual consumption characteristics across way groups to enable quantitative assessment of optimization strategies. Described architectures can also implement failure handling and recovery mechanisms while preserving power optimization objectives. If, e.g., preferred ways within closer groups become unavailable, the system follows defined fallback procedures to maintain cache functionality. A replacement policy can include specific handling for scenarios such as capacity constraints and priority conflicts, ensuring reliable operation across varying cache conditions. These recovery capabilities maintain system stability while adhering to power-aware allocation strategies.

Implementations can support incremental adoption across different cache structures. The programmable control structures allow selective enabling of distance-aware features on a per-client basis. Cache ways can be gradually organized into placement-based groups while maintaining backwards compatibility with existing cache protocols. This flexible deployment model enables progressive integration of power optimization capabilities based on system requirements and constraints. Further, described architectures achieve power optimization without compromising cache access latency or throughput. By maintaining standard cache protocols and interfaces, the system preserves existing performance characteristics while reducing power consumption through strategic resource allocation. The distance-aware mechanisms operate within established cache timing parameters, enabling power benefits without introducing additional access delays or reducing cache bandwidth capabilities.

In view of the foregoing, in certain implementations, a placement-aware cache replacement policy (PLAC) can manage cache allocation across varying utilization scenarios. According to one example, in high cache allocation scenarios, the system can allocate cache ways nearer to the LLCC controller for high frequency clients while assigning more distant ways to lower frequency clients. This allocation approach may be implemented through a programmable table structure maintaining per-client way assignments.

The cache architecture can include multiple physical cache banks configured as ways, where each way may comprise multiple physical cache blocks (PCBs). The PCBs can be arranged in a distributed configuration, with some PCBs located physically closer to the cache controller than others. For example, in one implementation supporting 20 ways with 16K sets, each way can include multiple 64 KB and 128 KB PCBs distributed across the silicon die. The tag RAM structure may maintain way assignments through dedicated storage for WAY0 through WAY19.

The cache architecture can implement distance-based allocation by tracking both client access frequencies and physical distances. In some examples, each client (CN1, CN2, CN3, etc.) may be assigned specific ways (w0, w1, w2, etc.) based on their measured access frequency (f1, f2, f3, etc.) and the physical distance (d1, d2, d3, etc.) of available ways from the controller. The system can be configured to maintain ordering relationships, such that if f1>f2>f3 represents relative access frequencies and d1>d2>d3 represents relative distances, ways can be allocated to optimize power consumption based on access patterns.

According to certain aspects, the architecture can dynamically adjust way assignments in response to changing access patterns. For example, if a first client initially assigned to a distant way demonstrates increased access frequency, the system may reassign that client to a closer way while relocating a lower-frequency client to the more distant location. This reallocation can be managed through updates to the way assignment tables while maintaining consistent cache functionality. The allocation mechanism can be implemented through a combination of hardware and software components. In some implementations, software-programmable registers in a Sub-Cache Table (SCT) can maintain way reservations for each client. The SCT may be configured to store both static assignments and dynamic allocation preferences. The hardware logic can then enforce these assignments during cache accesses while tracking actual utilization patterns.

Distance awareness can extend to physical addressing mechanisms. In some implementations, the cache may implement a standard address decomposition into block offset, set index, and tag fields. However, the way selection logic can incorporate physical distance information when determining placement of new cache lines. This approach optimizes power consumption without requiring modifications to the cache addressing scheme.

In implementations supporting 16K sets, the tag RAM structure can maintain way assignments through dedicated storage for each way (WAY0 through WAY19). The physical implementation can include PCBs of varying sizes (e.g., 64 KB, 128 KB) distributed across the silicon die according to physical design constraints. The allocation policy can then consider this physical distribution when assigning ways to different clients. The cache controller can be configured to maintain tables mapping client identifiers (e.g., SCID 0/1/2) to their assigned ways. The mapping may be updated based on monitored access patterns while preserving cache coherence requirements. Also, the controller logic can track both the frequency of accesses and the physical locations of assigned ways to optimize power consumption during sustained operation.

According to another implementation, a hardware-based placement-aware cache replacement policy (PLAC) may provide distance-based way management through modified replacement algorithms. In some instances, the architecture may incorporate both traditional NMRU/pseudo LRU replacement schemes and additional distance-aware selection logic to optimize power consumption during cache operations. Further, the cache ways may be organized into N distinct groups based on their physical distance from the controller logic. For example, in one possible implementation supporting a 20 MB cache configuration, the ways can be partitioned into two primary groups: Group 0 (G0) comprising Ways 0-9, and Group 1 (G1) comprising Ways 10-19. Such grouping may reflect the physical placement of PCBs and associated SRAM structures relative to the cache controller.

The cache architecture may maintain programmable way vectors for each distance-based group. In some examples, each way vector can comprise a multi-bit field where individual bits may represent the presence or availability of specific ways within that group. For instance, a first group vector (Grp0_placement_way_vec[19:0]) may be configured with a value of 0x003ff to indicate ways available in the first group, while a second group vector (Grp1_placement_way_vec[19:0]) may be configured with 0xffC00 to represent ways in the more distant group. here, in certain aspects, distance-aware replacement may be implemented through modified allocation and replacement algorithms. When a cache miss occurs, the replacement logic can be configured to first evaluate candidate ways from Group 0 before considering ways from Group 1. Such preference for closer ways may be integrated with traditional replacement policies while maintaining cache coherence and functionality.

The hardware architecture may, in some implementations, include dedicated logic for managing way selection across groups. For example, when processing a first miss (MISS1), the system can be configured to apply PLAC preference rules to prioritize selection from Group 0. A second miss (MISS2) occurring under different conditions may follow MRU preference rules within the constraints of the group-based organization. This dual-path approach may allow the system to balance power optimization with cache performance requirements.

According to some implementations, the architecture may implement per-client control through a programmable vector maintaining enable/disable settings for the distance-aware features. Each bit in this vector can correspond to a specific client identifier (SCID), potentially allowing selective application of the power optimization mechanisms. Such granular control may support mixed workloads where some clients benefit from distance awareness while others maintain traditional replacement patterns.

Also, the physical implementation may organize PCBs into group-aligned structures. For example, Group 0 can comprise multiple PCBs ranging from 64 KB to 128 KB in size, with DATA RAMS for Ways 0-9 potentially positioned closer to the controller. Group 1 may maintain a similar organization for Ways 10-19 but at greater physical distances. Such structured approach to PCB placement can facilitate power-aware way selection during cache operations.

The replacement logic may, in some implementations, be configured to maintain way selection preferences through programmable mask values. These masks can be updated dynamically to reflect changes in way availability or group organization while preserving the fundamental distance-aware selection policy. In certain instances, the logic may incorporate both the group-based preferences and traditional replacement metrics when determining way selection during cache misses. Described architectures may track allocation patterns through monitoring logic associated with each way group. Such monitoring can inform dynamic adjustments to the way vectors and selection preferences while maintaining consistent cache operation. The combination of hardware-based group management and programmable control structures may enable systematic power optimization across varying workload conditions.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

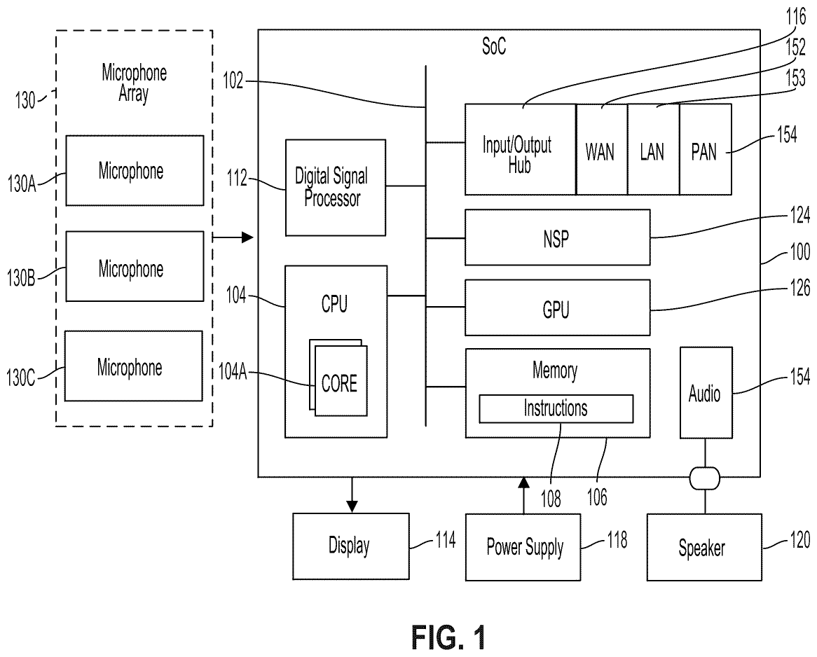

FIG. 1 shows a block diagram of a system-on-chip (SoC) configured for performing signal processing according to one or more aspects of this disclosure. The SoC 100 may include several components coupled together through a bus 102, which may be a network-on-a-chip (NoC) or a plurality of NOCs interconnecting various components. For example, although FIG. 1 illustrates several components coupled to the bus 102, the several components may be coupled to different busses with additional busses connecting the different busses to provide a path for communication between the components.

One example component in the SoC 100 is a digital signal processor 112 for signal processing. The DSP 112 may process audio signals received from microphones 130A, 130B, and 130C of microphone array 130. The DSP 112 may include hardware customized for performing a limited set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner.

The SoC 100 also includes a central processing unit (CPU) 104 and a memory 106 storing instructions 108 (e.g., a memory storing processor-readable code or a non-transitory computer-readable medium storing instructions) that may be executed by a processor of the SoC 100. The CPU 104 may be a single central processing unit (CPU) or a CPU cluster comprising two or more cores such as core 104A. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application). The CPU 104 may execute instructions 108 retrieved from the memory 106. In some embodiments, the CPU 104 executing an operating system may coordinate execution of instructions by various components within the SoC 100. For example, the CPU 104 may retrieve instructions 108 from memory 106 and execute the instructions on the DSP 112.

The SoC 100 may further include a neural signal processor (NSP) 124 for executing machine learning (ML) models relating to multimedia applications. The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). The ANN executed by the NSP 124 may access predefined training weights stored in the memory 106 for performing operations on user data.

The SoC 100 may be coupled to a display 114 for interacting with a user. The SoC 100 may also include a graphics processing unit (GPU) 126 for rendering images on the display 114. In some embodiments, the CPU 104 may perform rendering to the display 114 without a GPU 126. In some embodiments, the GPU 126 may be configured to execute instructions for performing operations unrelated to rendering images, such as for processing large volumes of datasets in parallel.

The SoC 100 may include an integrated circuit, such as included in one of the processors DSP 112, CPU 104, NSP 124, GPU 126, to implement a channel-less design-for-test (DFT) architecture. The DFT architecture includes multiple hardware modules (HMs) distributed across the integrated circuit, with one module designated as a center HM. Each HM incorporates dedicated DFT circuitry comprising a scan shift network (SSN) and an encoder/decoder for test (EDT) circuit to enable localized test operations. The HMs communicate through a standardized bus interface, eliminating traditional dedicated test routing channels. The center HM includes specialized SSN multiplexing circuitry that coordinates test operations across the distributed modules while maintaining independent test execution capabilities within each module. This distributed architecture supports efficient manufacturing test operations by integrating test components directly within the hardware modules and managing test data communication through the existing bus infrastructure. The implementation may include channel wrapper tiles with strategically positioned test circuits, on-chip clock distribution networks, and debug interfaces that enable comprehensive test coverage while minimizing routing overhead and implementation complexity. This approach aligns with the SoC's modular architecture while providing efficient test capabilities for verifying manufacturing quality and functional correctness of the integrated components.

Processing algorithms, techniques, and methods may be executed by at least one processor of the SoC 100, which may include execution by all steps on one of the processors (e.g., DSP 112, CPU 104, NSP 124, GPU 126) or may include execution of steps across a combination of one or more of the processors (e.g., DSP 112, CPU 104, NSP 124, GPU 126). The distributed design-for-test (DFT) architecture involves hardware-based test operations rather than software processing, with test functionality integrated directly into the hardware modules of the SoC 100. In some embodiments, at least one of the DSP 112 or the CPU 104 executes instructions to coordinate test operations across the distributed hardware modules through configuration of the DFT circuitry and management of test data communication. For example, the CPU 104 may configure the SSN multiplexing circuitry in the center hardware module to coordinate scan operations across multiple modules while maintaining independent test execution capabilities. The DFT operations enable comprehensive testing of the integrated components through scan chain operations, clock distribution, and debug interfaces implemented directly in hardware.

The CPU 104 may initialize test configurations and monitor test results while the actual test operations execute through dedicated hardware circuitry distributed across the modules. This hybrid approach leverages the CPU's control capabilities for test management while utilizing dedicated DFT components for efficient test execution. The hardware modules communicate test data through a standardized bus interface, eliminating traditional dedicated routing channels while maintaining comprehensive test coverage. Configuration of the test architecture may respond to system requirements or test modes, with the CPU 104 coordinating the overall test strategy while individual hardware modules execute their respective test operations independently.

Input/output components may be coupled to the SoC 100 through an input/output (I/O) hub 116. An example of a hub 116 is an interconnect to a peripheral component interconnect express (PCIe) bus. Example components coupled to hub 116 may be components used for interacting with a user, such as a touch screen interface and/or physical buttons. Some components coupled to hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna that may be shared by each of the adaptors 152, 153, and 154, or coupled to multiple antennas configured for primary and diversity reception and/or configured for receiving specific frequency bands. In some embodiments, the WAN adaptor 152, LAN adaptor 153, and/or PAN adaptor 154 may share circuitry, such as portions of a radio frequency front end (RFFE).

Audio circuitry 154 may be integrated in SoC 100 as dedicated circuitry for coupling the SoC 100 to a speaker 120 external to the SoC 100, which may be a transducer such as a speaker (either internal to or external to a device incorporating the SoC 100) or headphones. The audio circuitry 154 may include coder/decoder (CODEC) functionality for processing digital audio signals. The audio circuitry 154 may further include one or more amplifiers (e.g., a class-D amplifier) for driving a transducer coupled to the SoC 100 for outputting sounds generated during execution of applications by the SoC 100. Functionality related to audio signals described herein may be performed by a combination of the audio circuitry 154 and/or other processors of the SoC (e.g., CPU 104, DSP 112, GPU 126, NSP 124).

The SoC 100 may couple to external devices outside the package of the SoC 100. For example, the SoC 100 may be coupled to a power supply 118, such as a battery or an adaptor to couple the SoC 100 to an energy source. The signal processing described herein may be adapted to and achieve power efficiency to support operation of the SoC 100 from a limited-capacity power supply 118 such as a battery. For example, operations may be performed on a portion of the SoC 100 configured for performing the operation at a lowest power consumption. As another example, operations themselves are performed in a manner that reduces an amount of computations to perform the operation, such that the algorithm is optimized for extending the operational time of a device while powered by a limited-capacity power supply 118. In some embodiments, the operations described herein may be configured based on a type of power supply 118 providing energy to the SoC 100. For example, a first set of operations may be executed to perform a function when the power supply 118 is a wall adaptor. As another example, a second set of operations may be executed to perform a function when the power supply 118 is a battery.

The SoC 100 may also include or be coupled to additional features or components that are not shown in FIG. 1. Although components are shown integrated as a single SoC 100, which may include all components built on a single semiconductor die with a common semiconductor substrate, other arrangements of the illustrated blocks different number of dies, substrates, and/or packages may be arranged to accomplish the same functionality described in this disclosure.

The memory 106 may include a non-transient or non-transitory computer readable medium storing computer-executable instructions as instructions 108 to perform all or a portion of one or more operations described in this disclosure. The instructions 108 may include a multimedia application (or other suitable application such as a messaging application) to be executed by the SoC 100 that records, processes, or outputs audio signals. The instructions 108 may also include other applications or programs executed by the SoC 100, such as an operating system and applications other than for multimedia processing.

In addition to instructions 108, the memory 106 may also store audio data. The SoC 100 may be coupled to an external memory and configured to access the memory for writing output audio files for later playback or long-term storage. For example, the SoC 100 may be coupled to a flash storage device comprising NAND memory for storing video files (e.g., MP4-container formatted files) including audio tracks and/or storing audio recordings (e.g., MPEG-1 Layer 3 files, also referred to as MP3 files). Portions of the video or audio files may be transferred to memory 106 for processing by the SoC 100, with the resulting signals after processing encoded as video or audio files in the memory 106 for transfer to the long-term storage.

While the SoC 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

The SoC of FIG. 1 implements a placement-aware cache architecture that improves power efficiency and system performance through strategically positioned cache ways across the silicon die. This architecture enhances power optimization and reduces dynamic consumption by considering physical distances between cache ways and the last-level cache controller (LLCC) during allocation and replacement operations. The distance-aware approach enables independent way management for high-frequency and low-frequency clients while maintaining coordinated cache operations through centralized control logic and sub-cache tables. This results in reduced power consumption, optimized physical design, and improved cache utilization efficiency. The integration of power-aware allocation directly within the cache logic, combined with distance-based way grouping and programmable control vectors, provides full cache functionality while minimizing power overhead. The system achieves up to 80% reduction in dynamic power consumption for common access patterns by preferentially allocating closer ways to high-frequency and active clients.

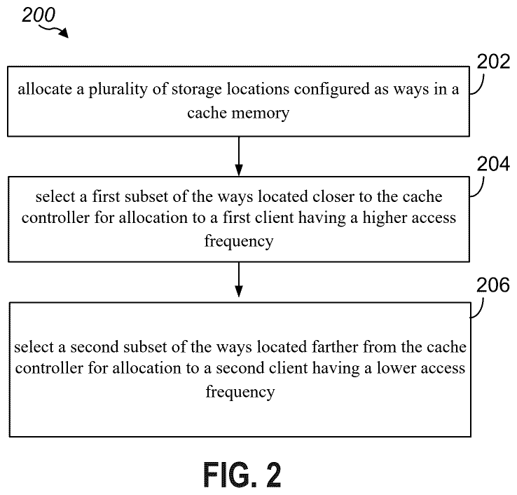

FIG. 2 shows a flowchart illustrating a process 200 performable by an integrated circuit device that supports placement-aware cache allocation operations according to the concepts described herein. A semiconductor device operating as or in conjunction with SoC 100 shown in FIG. 1 or its components may implement the operations of process 200. For example, an integrated circuit device such as a system-on-chip (SoC) implementing last-level cache control can perform the process 200 while configured to support distance-based way allocation.

At step 202, the device allocates a plurality of storage locations configured as ways in a cache memory. In certain implementations, these storage locations can be organized into physical cache blocks (PCBs) ranging from 64 KB to 128 KB in size, with 20 total ways distributed across tag RAM structures supporting 16K sets. The architecture may implement sub-cache table (SCT) structures storing way reservations for each client, where the SCT maintains dynamic mapping tables that track both way assignments and client states. These SCT structures enable systematic tracking of way assignments while supporting allocation updates responsive to changes in client access patterns or activity states.

At step 204, the device selects a first subset of the ways located closer to the cache controller for allocation to a first client having a higher access frequency. For example, in implementations supporting high cache allocation scenarios, ways w0-w2 physically closer to the LLCC controller may be assigned to clients CN1-CN3 based on their relative access frequencies f1-f3. Process 200 can maintain distance metrics d1-d3 reflecting the physical placement of ways relative to the controller, where d1>d2>d3 represents increasing proximity to the controller. The selection of closer ways for higher frequency clients directly enables power optimization, as accessing these ways can reduce dynamic power consumption by up to 80% compared to accessing distant ways.

At step 206, the device selects a second subset of the ways located farther from the cache controller for allocation to a second client having a lower access frequency. Step 206 can occur in coordination with the first subset allocation to maintain balanced cache utilization. In certain implementations supporting low cache allocation scenarios, e.g., ways w3-w5 physically distant from the controller may be assigned to clients having reduced access frequencies or inactive status. The cache logic monitors client access patterns to enable dynamic reallocation between the first and second subsets, tracking both frequency changes and client state transitions to maintain optimal power efficiency.

For implementations incorporating active/inactive client management, additional steps configure way assignments based on client state. The cache logic can allocate ways located closer to the cache controller (e.g., w0-w2) to active clients while directing inactive client accesses to more distant ways (e.g., w3-w5). Doing so maintains power efficiency during periods of varying client activity.

The process 200 can include steps for managing multi-core access patterns where the first and second clients comprise different processing cores accessing the cache memory. For example, through programmable way vectors (e.g., Grp0_placement_way_vec[19:0]=0x003ff), the system can maintain distinct way groupings while enabling coordinated access across multiple cores. The cache controller can coordinate these assignments through client control vectors enabling or disabling way group preferences on a per-client basis.

Throughout execution, process 200 can maintain dynamic adaptation capabilities through continuous monitoring. According to process 200, a device can track access frequencies of active clients and reallocates ways between the first and second subsets when frequency changes occur. Client state information indicating active/inactive status enables automated reallocation responsive to state transitions. This placement-aware approach achieves substantial power reduction while preserving cache functionality across varying workload conditions.

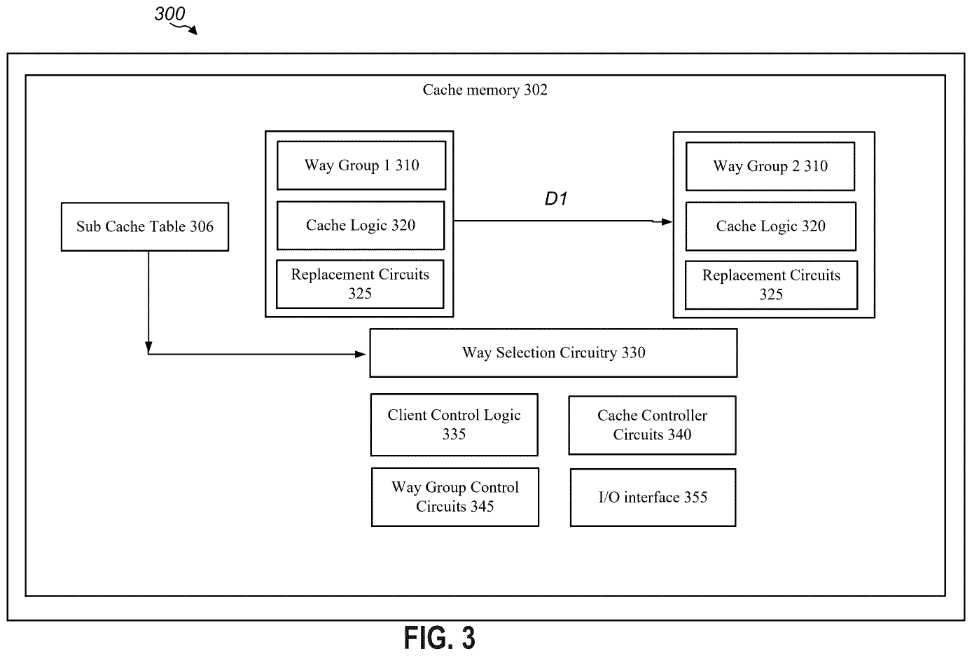

FIG. 3 is a block diagram of an example system-on-chip (SoC) apparatus 300 that supports placement-aware cache operations according to aspects described herein. Apparatus 300 may be an example of aspects of the SoC described in the previous figures. Apparatus 300 may include various components described herein, and one or more components of apparatus 300 may include at least one processor, which may be coupled with at least one memory, to support or enable the described techniques. Each of these components may be in communication with one another via one or more buses.

Apparatus 300 includes a cache memory 302 having multiple ways interconnected through cache control interfaces, with dedicated way groups 310, separated by a distance D1, and organized based on physical distance from a central cache controller. As discussed herein, each way group contains cache logic configured to execute local cache operations while maintaining coordinated access through the controller infrastructure. The distance-aware architecture enables independent way management while preserving control through centralized allocation functions. This approach optimizes power consumption and simplifies physical design implementation across the system.

Each way group 310 includes cache allocation logic 320 and replacement circuits 325 for processing cache accesses and managing way assignments within their respective groups. The cache memory 302 additionally incorporates way selection circuitry 330 that coordinates operations across the distributed architecture while preserving power optimization. Way selection circuitry 330 is coupled to sub-cache table 306, which maintains all way assignments and client state information. Through this interface, cache allocation decisions flow between way groups according to standardized protocols that support both high and low allocation scenarios. The sub-cache table 306 may implement programmable vectors (e.g., Grp0_placement_way_vec[19:0]) to provide sufficient control while maintaining allocation efficiency. Some implementations incorporate monitoring mechanisms to ensure optimal way assignment across varying access patterns.

Apparatus 300 may include client control logic 335 incorporating specialized cache components positioned for optimal power management. The logic 335 can contain allocation and replacement circuits with access monitoring circuitry placed at client interfaces. The client control logic 335 can support multiple processing cores through strategically positioned cache components that minimize power consumption while enabling efficient way allocation and replacement. Activity tracking circuitry within the logic provides flexible allocation options for different client states. Cache access monitoring networks (not illustrated) extend from the interface points to maintain synchronized operation across clients.

Apparatus 300 may include way group control circuits 345 distributed across the cache banks, with, in some implementations, a central allocation circuit located in the cache controller. This circuitry enables unified cache management through single control interfaces while maintaining independent way group operation. Input/output interfaces 355 handle transitions between different client domains across the cache system. These interfaces support multiple operating modes to accommodate various allocation requirements and system configurations.

Apparatus 300 may also include cache controller circuits 340 integrated within each way group to manage local allocation operations. Controller circuits 340 coordinate with the way group control circuits 345 and allocation registers to provide cache functionality while minimizing power consumption. The controllers 340 also handle replacement operations, access monitoring, and way selection based on specific client requirements. Certain implementations may incorporate built-in power monitoring capabilities and utilization tracking features through dedicated measurement points within the cache infrastructure.

Apparatus 300 can operate across different cache utilization scenarios through consistent allocation policies that support both high and low cache allocation implementations. Dedicated client interfaces coupled to appropriate control circuits enable seamless transition between allocation levels without compromising cache functionality. The architecture accommodates various client types and activity states through modules that manage transitions across way groups. Implementation flexibility extends to handling different client requirements and access patterns through adaptable way assignment and configurable allocation resources.

As mentioned, the placement-aware cache architecture implemented by apparatus 300 supports efficient power optimization while minimizing implementation complexity. Way allocation and replacement proceed according to physical distance considerations for each client group, reducing overall power consumption. The modular approach enables parallel cache access across multiple clients while maintaining coordinated control through the central cache controller. Further, built-in monitoring capabilities support dynamic optimization through integrated observation and control points throughout the cache infrastructure.

Various components of apparatus 300 provide means for performing method 200 described with respect to FIG. 2. For example, means for allocating storage locations may include sub-cache table 306 and way selection circuitry 330. Means for selecting way subsets may include allocation logic 320 and replacement circuits 325. Means for managing client assignments may include the way selection circuitry 330 in conjunction with cache controller circuits 340. Additional components provide support for specialized allocation functions, monitoring operations, and system integration requirements as described throughout this disclosure.

The operations described with reference to blocks of FIG. 3 may be performed on a digital signal processor (DSP), such as DSP 112 of the SoC 100 illustrated in FIG. 1. However, the operations may alternatively be performed by one or more of the processors of FIG. 1, including one or more of the CPU 104, the DSP 112, the GPU 126, or the NSP 124. For example, the CPU 104 may maintain cache allocation tables in memory 106 as part of the operations of block 302. The DSP 112 may then perform the operations of blocks 304 and 306 on the cache assignments stored in memory 106, after which updated allocation information determined by the DSP 112 may be stored in memory 106 and used to configure cache way assignments across the system. In another example, the processor performing the operations of blocks 302, 304, and/or 306 may be dedicated cache control circuitry for performing certain operations.

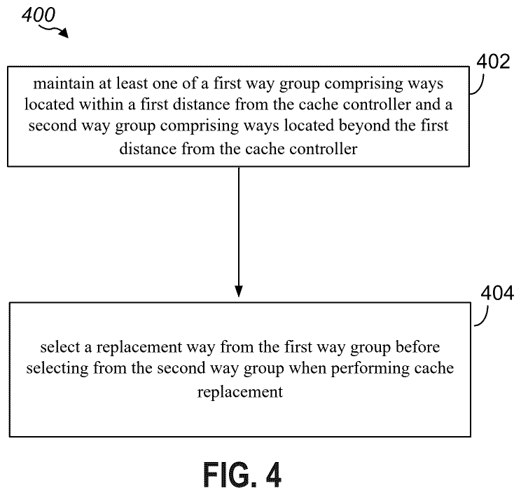

FIG. 4 shows a flowchart illustrating a process 400 performable by an integrated circuit device that supports placement-aware cache replacement operations according to aspects described herein. A semiconductor device operating as or in conjunction with SoC 100 shown in FIG. 1 or its components may implement the operations of process 400. For example, an integrated circuit device such as a system-on-chip (SoC) implementing last-level cache control can perform the process 400 while configured to support distance-based replacement strategies.

At step 402, the device maintains at least one of a first way group comprising ways located within a first distance from the cache controller and a second way group comprising ways located beyond the first distance from the cache controller. In certain implementations, the first group (G0) may comprise Ways 0-9 in a 20 MB cache configuration, with each way including multiple PCBs ranging from 64 KB to 128 KB, while the second group (G1) may comprise Ways 10-19. The system can maintain these group assignments through programmable way vectors, where a first group vector (Grp0_placement_way_vec[19:0]=0x003ff) indicates available ways within the closer physical group and a second programmable vector (Grp1_placement_way_vec[19:0]=0xffC00) manages the more distant group. The central positioning of the first way group reduces power consumption while enabling efficient access patterns. The sub-cache table (SCT) maintains client-specific way reservations through dedicated storage elements, with interface circuits handling state transitions between way groups. Process 400 can incorporate client control vectors enabling or disabling way group preferences on a per-client basis to allow for selective application of distance-aware replacement policies across different clients. Some implementations subdivide the way groups to accommodate additional monitoring components or specialized routing requirements based on specific client access patterns. The SCT implementation allows configuration of way resources based on specific client requirements, including, e.g., options for shared way allocation between adjacent clients or dedicated way assignments based on access patterns.

At step 404, the device selects a replacement way from the first way group before selecting from the second way group when performing cache replacement. This selection at step 404 implements a structured evaluation sequence that first examines the first way group for invalid lines, then checks the second way group only if no invalid lines are found in the first group. Upon finding no invalid lines in both groups, the logic can check for deactivated lines first in the first way group, then in the second group only if necessary. This sequence can extend to over-capacity line checking, maintaining the distance-aware preference through each evaluation stage. The replacement logic incorporates specialized monitoring circuits that track line status across both groups while maintaining signal integrity through proper component placement.

For implementations incorporating priority-based replacement, the device evaluates lines according to priority levels while maintaining the group-based sequence. Within each way group, the cache logic checks for lower priority lines before considering equal priority lines, implementing a modified least-recently-used (LRU) policy that systematically prioritizes ways in the first group over the second group. Interface circuits manage transitions between priority levels, ensuring consistent replacement operations regardless of way group boundaries. The hardware implements dedicated priority tracking logic with programmable threshold registers that adapt to changing workload conditions.

Process 400 can include specialized mechanisms for handling replacement within each way group. For example, when operating within a single group, the cache logic performs most-recently-used replacement while adhering to the overall distance-based grouping strategy. The placement-aware architecture coordinates operations with the central cache controller that manages system-level allocation functions while maintaining local control over group-specific replacement operations. Built-in debug capabilities support replacement pattern validation through dedicated observation points within the way group structure, enabling continuous optimization of power efficiency.

Throughout execution, process 400 maintains power optimization through physical placement awareness. Access operations targeting ways in the first way group produce measurably less power consumption than operations involving the second way group, with dynamic power reductions of up to 80% observed when accessing closer ways. Way selection algorithms optimize resource utilization across multiple way groups operating simultaneously, while monitoring circuits track power consumption patterns to enable dynamic optimization. The modular implementation simplifies verification efforts by allowing independent power characterization of group-level functions before system integration.

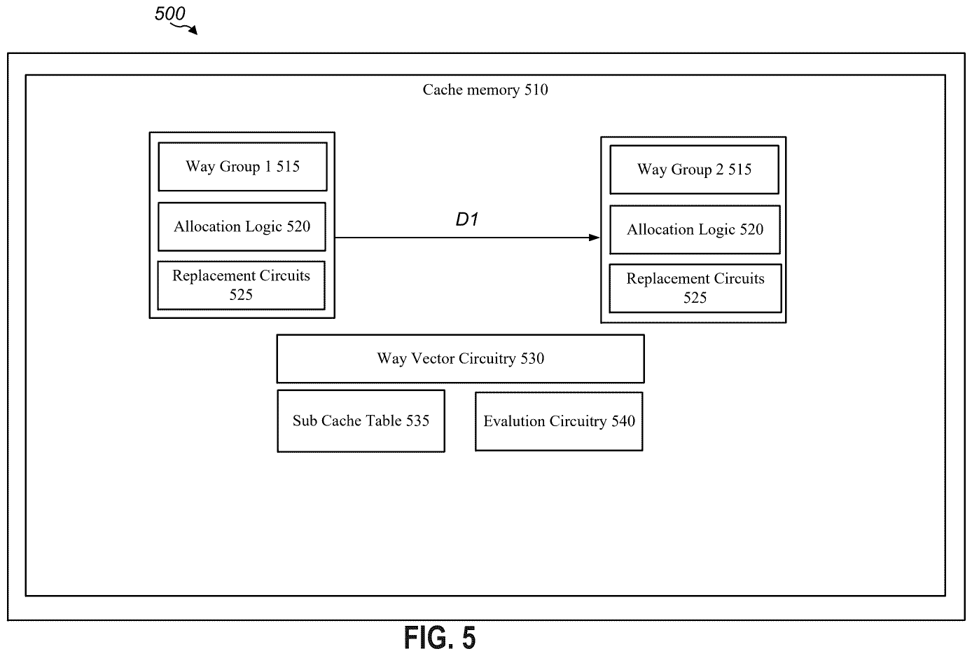

FIG. 5 is a block diagram of an example system-on-chip (SoC) apparatus 500 that implements a placement-aware cache architecture through distance-based way groups according to aspects described herein. Apparatus 500 may be an example of aspects of the SoC described in the previous figures. Apparatus 500 may include various components described herein, and one or more components may include at least one processor coupled with memory to support the described techniques. Each component may communicate with others via one or more buses.

Apparatus 500 includes a cache memory structure 510 containing multiple way groups 515, separated by a distance D1, configured for distance-aware cache operations. The way groups 515 provide dedicated storage paths while maintaining power efficiency through strategic component placement. This architecture enables efficient cache access distribution while minimizing power consumption through optimized placement of cache circuitry within the way group structure. The cache memory 510 can incorporate allocation logic 520 and replacement circuitry 525 positioned relative to their assigned way groups. These components can process cache access patterns and manage replacement operations across the way groups. Allocation logic 520 handles dynamic way assignment, while replacement circuitry 525 coordinates cache line selection throughout the group structure. The distance-based positioning reduces power consumption while enabling efficient access to all ways. Implementations can include subdividing cache resources across multiple way groups or sharing allocation resources between adjacent clients based on access requirements.

Apparatus 500 also includes programmable way vector circuitry 530 (e.g., Grp0_placement_way_vec[19:0]=0x003ff) placed at interfaces of the way groups 515, where the placement enables coordinated way selection while maintaining power optimization between groups. Control networks extend from these interface points to individual cache components within each group, maintaining power-aware relationships across the cache structure. The way vector circuitry 530 supports multiple client domains through unified allocation and control circuits, with interface components managing client priority transitions between groups operating under different access patterns.

A sub-cache table 535 couples the allocation and replacement circuits to client interface 505, enabling coordinated cache operations across the broader system. The sub-cache table 535 maintains way reservations and client state information between the cache groups and other system components according to standardized protocols. The client interface 505 supports different allocation modes while maintaining power efficiency through proper way assignment and monitoring at group boundaries.

Apparatus 500 further includes priority-based evaluation circuitry 540 configured within the group structure. The evaluation circuitry 540 enables systematic line evaluation between way groups and supports efficient replacement through local priority assessment paths and provides flexibility in cache resource utilization by allowing differentiated handling of lower and equal priority lines across multiple groups when possible. Implementation can include, e.g., dedicated evaluation paths for specific replacement scenarios or configurable priority mechanisms that adapt to different client access patterns.

Various implementations of apparatus 500 support different allocation scenarios through adaptive placement of cache components. For instance, high allocation scenarios maintain power efficiency through compact way groupings, while low allocation scenarios may incorporate additional way distribution without disrupting the overall architecture. Interface circuits manage state transitions between clients of varying activity levels, ensuring consistent operation across the cache structure.

The placement-aware architecture of apparatus 500 coordinates with system-level cache management while maintaining local control over group operations. Built-in monitoring capabilities support power optimization through dedicated measurement points within the group structure. The cache memory may interact with central controller modules that manage system-wide allocation functions, enabling comprehensive coverage while preserving the benefits of distributed control. This includes maintenance of most-recently-used (MRU) replacement within groups while adhering to the broader distance-aware strategy.

Various components of apparatus 500 may provide means for implementing placement-aware cache functionality associated with process 400. For example, means for maintaining way groups may include the way grouping logic 520 and distance tracking circuits 525. Means for managing programmable vectors may include way vector circuitry 530 and client control vectors 532. Means for performing replacement operations may include evaluation sequencing logic 535 configured to check invalid lines, deactivated lines, and over-capacity lines in group order. Means for priority-based selection may include priority tracking circuits 540 implementing modified LRU policies within and across groups. Means for monitoring power consumption differences between groups may include power measurement circuits 545. Additional components provide specialized functions supporting MRU maintenance within groups, client preference management, and system integration as described throughout this disclosure.

The operations described with reference to blocks of FIG. 5 may be performed on a digital signal processor (DSP), such as DSP 112 of the SoC 100 illustrated in FIG. 1. However, the operations may alternatively be performed by one or more of the processors of FIG. 1, including one or more of the CPU 104, the DSP 112, the GPU 126, or the NSP 124. For example, the CPU 104 may maintain allocation tables in memory 106 as part of the way group operations. The DSP 112 may then perform cache operations accessing these way groups, after which power consumption data determined by the monitoring circuits may be stored in memory 106 to inform future allocation decisions. In another example, the processor performing these operations may be dedicated cache control circuitry for performing certain operations.

In one or more aspects, techniques for improving cache power efficiency may include additional aspects, such as any single aspect or any combination of aspects described below or in connection with one or more other processes or devices described elsewhere herein. In a first aspect, a device with improved power consumption may include an apparatus comprising a cache memory including a plurality of storage locations configured as ways, a cache controller, and cache logic configured to implement distance-aware way allocation. The cache logic is configured to select subsets of ways based on their physical distance from the cache controller and allocate them according to client access frequencies, with closer ways being assigned to higher-frequency clients. The apparatus is further configured to maintain way assignments through programmable control structures while executing independent cache operations through standardized interfaces. Additionally, the apparatus may perform or operate according to one or more aspects as described below.

In some implementations, the apparatus includes an integrated circuit device, such as a system-on-chip (SoC) implementing the placement-aware cache architecture. In other implementations, the apparatus includes a semiconductor device having distance-aware cache components which enable efficient power management through localized way allocation. In some implementations, the apparatus may include hardware cache circuits and memory components coupled to cache control logic. The hardware circuits may be configured to perform cache operations described herein with respect to the apparatus. In some other implementations, the apparatus may include cache controller circuits having configuration data recorded thereon, where the configuration data enables the controller to perform operations described herein with reference to the apparatus. In some implementations, the apparatus may include one or more cache interface components configured to perform operations described herein. In some implementations, a method of performing placement-aware cache operations may include one or more operations described herein with reference to the apparatus.

In a first aspect, an apparatus comprises: a cache memory including a plurality of storage locations configured as ways; a cache controller; and cache logic configured to: select a first subset of the ways located closer to the cache controller for allocation to a first client having a higher access frequency; and select a second subset of the ways located farther from the cache controller for allocation to a second client having a lower access frequency.

In a second aspect, in combination with the first aspect, the cache logic includes a sub-cache table storing way reservations for each client.

In a third aspect, in combination with one or more of the first aspect or the second aspect, accessing the first subset of ways is associated with lower power consumption than accessing the second subset of ways.

In a fourth aspect, in combination with one or more of the first aspect through the third aspect, the cache logic is further configured to allocate ways located closer to the cache controller to active clients and ways located farther from the cache controller to inactive clients.

In a fifth aspect, in combination with one or more of the first aspect through the fourth aspect, the first client and second client comprise different processing cores accessing the cache memory.

In a sixth aspect, a cache system comprises: a cache memory having a plurality of storage locations configured as ways in cache banks; a cache controller; and cache logic configured to: maintain at least one of a first way group comprising ways located within a first distance from the cache controller and a second way group comprising ways located beyond the first distance from the cache controller; and select a replacement way from the first way group before selecting from the second way group when performing cache replacement.

In a seventh aspect, in combination with the sixth aspect, the cache system further comprises a programmable vector storing way assignments for the first and second way groups.

In an eighth aspect, in combination with one or more of the sixth aspect or the seventh aspect, the cache system further comprises a client control vector enabling or disabling way group preferences on a per-client basis.

In a ninth aspect, in combination with one or more of the sixth aspect through the eighth aspect, the cache logic performs most-recently-used replacement within each way group.

In a tenth aspect, in combination with one or more of the sixth aspect through the ninth aspect, accessing ways in the first way group produces less power consumption than accessing ways in the second way group.

In an eleventh aspect, in combination with one or more of the sixth aspect through the tenth aspect, the cache logic is configured to: check for invalid lines in the first way group; check for invalid lines in the second way group responsive to finding no invalid lines in the first way group; check for deactivated lines in the first way group responsive to finding no invalid lines in both groups; and check for deactivated lines in the second way group responsive to finding no deactivated lines in the first way group.

In a twelfth aspect, in combination with one or more of the sixth aspect through the eleventh aspect, the cache logic is configured to: check for over-capacity lines in the first way group responsive to finding no deactivated lines in both groups; and check for over-capacity lines in the second way group responsive to finding no over-capacity lines in the first way group.

In a thirteenth aspect, in combination with one or more of the sixth aspect through the twelfth aspect, the cache logic is configured to evaluate lines in the first way group according to priority levels before evaluating lines in the second way group.

In a fourteenth aspect, in combination with one or more of the sixth aspect through the thirteenth aspect, evaluating lines comprises checking for lower priority lines before equal priority lines within each way group.

In a fifteenth aspect, in combination with one or more of the sixth aspect through the fourteenth aspect, the cache logic selects the replacement way according to a modified least-recently-used policy that prioritizes ways in the first way group over ways in the second way group.

In a sixteenth aspect, a method comprises: allocating a plurality of storage locations configured as ways in a cache memory; selecting a first subset of the ways located closer to a cache controller for allocation to a first client having a higher access frequency; and selecting a second subset of the ways located farther from the cache controller for allocation to a second client having a lower access frequency.

In a seventeenth aspect, in combination with the sixteenth aspect, the method comprises storing way reservations for each client in a sub-cache table.

In an eighteenth aspect, in combination with one or more of the sixteenth aspect or the seventeenth aspect, accessing the first subset of ways is associated with lower power consumption than accessing the second subset of ways.

In a nineteenth aspect, in combination with one or more of the sixteenth aspect through the eighteenth aspect, the method comprises: allocating ways located closer to the cache controller to active clients; and allocating ways located farther from the cache controller to inactive clients.

In a twentieth aspect, in combination with one or more of the sixteenth aspect through the nineteenth aspect, the first client and second client comprise different processing cores accessing the cache memory.

In a twenty-first aspect, in combination with one or more of the sixteenth aspect through the twentieth aspect, the method comprises: monitoring access frequencies of the first and second clients; and reallocating ways between the first and second subsets responsive to changes in the access frequencies.

In a twenty-second aspect, in combination with one or more of the sixteenth aspect through the twenty-first aspect, the method comprises: storing client state information indicating whether each client is active or inactive; and reallocating ways between clients responsive to changes in client state information.

In a twenty-third aspect, in combination with one or more of the first aspect through the twenty-second aspect, a system-on-chip (SoC) comprises cache control circuitry configured to perform operations in accordance with any of the first through twenty-second aspects.

In a twenty-fourth aspect, in combination with one or more of the first aspect through the twenty-third aspect, an integrated circuit implements a placement-aware cache architecture comprising: the cache memory including the plurality of storage locations configured as ways; cache control circuitry; and cache management components configured to perform the operations described in any of the first through twenty-second aspects.

In a twenty-fifth aspect, in combination with one or more of the first aspect through the twenty-fourth aspect, a semiconductor device implementing the placement-aware cache architecture comprises: cache control circuitry; communication interfaces; and hardware components configured to perform the operations described in any of the first through twenty-second aspects.

In a twenty-sixth aspect, in combination with one or more of the first aspect through the twenty-fifth aspect, the semiconductor device comprises means for performing the method described in the sixteenth through twenty-second aspects.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 2 may be combined with one or more blocks (or operations) described with reference to another of the figures. For example, one or more blocks (or operations) of FIG. 2 may be combined with one or more blocks (or operations) of FIG. 4 or FIG. 1. As another example, one or more blocks associated with FIG. 5 may be combined with one or more blocks (or operations) associated with FIGS. 1-3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus comprising:
a cache memory including a plurality of storage locations configured as ways;
a cache controller; and
cache logic configured to:
select a first subset of the ways located closer to the cache controller for allocation to a first client having a higher access frequency; and
select a second subset of the ways located farther from the cache controller for allocation to a second client having a lower access frequency.

2. The apparatus of claim 1, wherein the cache logic includes a sub-cache table storing way reservations for each client.

3. The apparatus of claim 1, wherein accessing the first subset of ways is associated with lower power consumption than accessing the second subset of ways.

4. The apparatus of claim 1, wherein the cache logic is further configured to allocate ways located closer to the cache controller to active clients and ways located farther from the cache controller to inactive clients.

5. The apparatus of claim 1, wherein the first client and second client comprise different processing cores accessing the cache memory.

6. A cache system comprising:
a cache memory having a plurality of storage locations configured as ways in cache banks;
a cache controller; and
cache logic configured to:
maintain a first way group comprising ways located within a first distance from the cache controller and a second way group comprising ways located beyond the first distance from the cache controller; and
select a replacement way from the first way group before selecting from the second way group when performing cache replacement.

7. The cache system of claim 6, further comprising: a programmable vector storing way assignments for the first and second way groups.

8. The cache system of claim 7, further comprising: a client control vector enabling or disabling way group preferences on a per-client basis.

9. The cache system of claim 6, wherein the cache logic performs most-recently-used replacement within each way group.

10. The cache system of claim 6, wherein accessing ways in the first way group produces less power consumption than accessing ways in the second way group.

11. The cache system of claim 6, wherein the cache logic is configured to:
check for invalid lines in the first way group;
check for invalid lines in the second way group responsive to finding no invalid lines in the first way group;
check for deactivated lines in the first way group responsive to finding no invalid lines in both groups; and
check for deactivated lines in the second way group responsive to finding no deactivated lines in the first way group.

12. The cache system of claim 11, wherein the cache logic is configured to:
check for over-capacity lines in the first way group responsive to finding no deactivated lines in both groups; and
check for over-capacity lines in the second way group responsive to finding no over-capacity lines in the first way group.

13. The cache system of claim 12, wherein the cache logic is configured to:
evaluate lines in the first way group according to priority levels before evaluating lines in the second way group.

14. The cache system of claim 13, wherein evaluating lines comprises:
checking for lower priority lines before equal priority lines within each way group.

15. The cache system of claim 6, wherein the cache logic selects the replacement way according to a modified least-recently-used policy that prioritizes ways in the first way group over ways in the second way group.

16. A method comprising:
allocating a plurality of storage locations configured as ways in a cache memory;
selecting a first subset of the ways located closer to a cache controller for allocation to a first client having a higher access frequency; and
selecting a second subset of the ways located farther from the cache controller for allocation to a second client having a lower access frequency.

17. The method of claim 16, comprising storing way reservations for each client in a sub-cache table.

18. The method of claim 16, wherein accessing the first subset of ways is associated with lower power consumption than accessing the second subset of ways.

19. The method of claim 16, comprising:
allocating ways located closer to the cache controller to active clients; and
allocating ways located farther from the cache controller to inactive clients.

20. The method of claim 16, wherein the first client and second client comprise different processing cores accessing the cache memory.

21. The method of claim 16, comprising:
monitoring access frequencies of the first and second clients; and
reallocating ways between the first and second subsets responsive to changes in the access frequencies.

22. The method of claim 16, comprising:
storing client state information indicating whether each client is active or inactive; and
reallocating ways between clients responsive to changes in client state information.
